(19) United States
(12) Patent Application Publication
(10) Pub. No.: US 2015/0378440 A1
(43) Pub. Date: Dec. 31, 2015

(54) Dynamically Directing Interpretation of Input Data Based on Contextual Information

(71) Applicant: Microsoft Technology Licensing, LLC, Redmond, WA (US)

(72) Inventors: Eike Jens Umlauf, Tamworth (GB); Andrew John Preston, Warwickshire (GB); Christopher Richard Marlow, Hinkley (GB)

(21) Appl. No.: 14/318,275

(22) Filed: Jun. 27, 2014

(51) Int. Cl. G06F 3/01; G06T 7/20; G06F 3/00

(52) U.S. Cl. CPC G06F 3/017; G06F 3/005; G06T 7/20

(57) ABSTRACT

Technologies are described herein for dynamically directing an interpretation of input data based on contextual information associated with a virtual environment. According to one aspect of the disclosure, a computing device and a camera operate in concert to capture and interpret gestures of a human target to control a virtual skeleton, which may be visually represented as an avatar. Embodiments disclosed herein utilize filtering parameters in the interpretation of input data representing a state of the human target to generate output data that is used to direct the virtual skeleton and/or the avatar. The filtering parameters may be dynamically adjusted during runtime based on contextual information and other factors to dynamically change the way input data is interpreted. Dynamic adjustment of the filtering parameters during runtime may allow for an interpretation of input data that is more accurately aligned with a scenario presented in the virtual environment.

### BACKGROUND

While camera technology allows images of humans to be recorded, computers have traditionally not been able to use such images to accurately assess how a human is moving within the images. Recently, technology has advanced such that some aspects of a human's movements may be interpreted and used as input to a device. For example, a device may interpret a hand movement as a gesture to activate one or more functions of an application.

Although there have been some advancements in full-body motion sensors, the interpretation of certain gestures have room for improvement. For example, some existing systems tend to have trouble interpreting specific states of certain types of input. As one specific example, it may be difficult for some systems to accurately interpret precise joint positions. In addition, some systems produce unpredictable results when interpreting an image of a hand, mouth or eyes. For example, it may be difficult to determine if a user's hand is open or closed into a fist. Consequently, current techniques for interpreting input image data for gameplay or control of an application may result in a poor experience for the user.

It is with respect to these and other considerations that the disclosure made herein is presented.

### SUMMARY

Technologies are described herein for dynamically directing an interpretation of input data based on contextual information associated with a virtual environment. According to one aspect of the disclosure, a computing device and a camera operate in concert to capture and interpret gestures of a human target to control a virtual skeleton, which may be graphically represented, such as, by an avatar. Embodiments disclosed herein utilize filtering parameters to direct the interpretation of input data that represents a state of the human target. The interpreted input data influences the generation of output data that is used to direct the virtual skeleton and/or the avatar. The filtering parameters may be dynamically adjusted during runtime based on one or more scenarios to dynamically change the way input data is interpreted. Dynamic adjustment of the filtering parameters during runtime may allow for a more accurate interpretation of input data that is more aligned with a scenario presented in the virtual environment.

According to embodiments disclosed herein, the computing device is configured to control one or more scenarios within a virtual environment. A scenario may include any action, setting, surrounding, and/or any circumstance associated with the avatar. As scenarios are introduced during runtime, the filtering parameters may be dynamically selected to modify the interpretation of the input data as different scenarios are introduced. For example, if a virtual environment includes an avatar throwing a bowling ball, there may be one set of filtering parameters for the backswing and another set of filtering parameters for the forward swing. In such an example, dynamic changes to the filtering parameters assist in the interpretation of the input data to more accurately detect a state change of the human target, e.g., when the user opens their hand to release the ball.

In an illustrative embodiment, the camera captures images of the human target to produce input data describing a state of one or more objects of the human target, such as a hand, eyes, mouth, etc. For instance, an individual input data sample may indicate that an input object of the human target, e.g., a hand, is in a particular state, e.g., open or closed. The input data may also include additional states, such as an unknown state. Techniques described herein process the input data to determine if a state change of the input object should change the state of a virtual object that graphically corresponds to the input object of the human target.

As input data samples are received, contextual information, which may include data describing a scenario, is analyzed to select one or more filtering parameters. The selected filtering parameters may include a range of weight values and one or more thresholds. The selected weight values may then be associated with the input data samples, and the selected weight values may be analyzed to determine if the selected weight values meet a condition of the selected threshold. If the selected weight values meet the condition of the selected threshold, a state of the virtual object may be modified in accordance with the interpretation of the input data.

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a pictorial diagram showing an image analysis system being utilized to view an example observed scene in accordance with an embodiment of the present disclosure;

FIG. 2 is a pictorial diagram illustrating aspects of the modeling of a human target with a virtual skeleton and an avatar, in accordance with embodiments of the present disclosure;

FIG. 3 is a pictorial diagram showing a virtual skeleton reacting to an interpretation of input data received from a human target, in accordance with embodiments of the present disclosure;

FIG. 4 is a block diagram representing example components for processing input data and weight data to create an output, in accordance with embodiments of the present disclosure;

FIG. 5 is a flow diagram illustrating aspects of one illustrative routine for processing input data and weight data to create an output, according to one embodiment disclosed herein;

FIGS. 6A-6C are block diagrams showing an example of how input data samples may be related to filtering parameters;

FIGS. 7A-7C are block diagrams showing another example of how input data samples may be related to filtering parameters; and

FIG. 8 is a computer architecture diagram showing an illustrative computer hardware and software architecture for a computing system capable of implementing aspects of the embodiments presented herein.

### DETAILED DESCRIPTION

The following detailed description is directed to technologies for dynamically directing an interpretation of input data based on contextual information associated with a virtual environment. According to one aspect of the disclosure, a computing device and a camera operate in concert to capture and interpret gestures of a human target to control a virtual skeleton, which may be graphically represented as an avatar. Embodiments disclosed herein utilize filtering parameters to direct the interpretation of input data that represents a state of the human target, which influences the generation of output data that is used to direct the virtual skeleton and/or the avatar. The filtering parameters may be dynamically adjusted during runtime in accordance with contextual information and other factors, such as one or more scenarios, to dynamically change the way input data is interpreted. Dynamic adjustment of the filtering parameters during runtime may allow for an interpretation of input data that is more accurately aligned with a scenario presented in the virtual environment.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system and methodology for dynamically directing an interpretation of input data based on contextual information will be described.

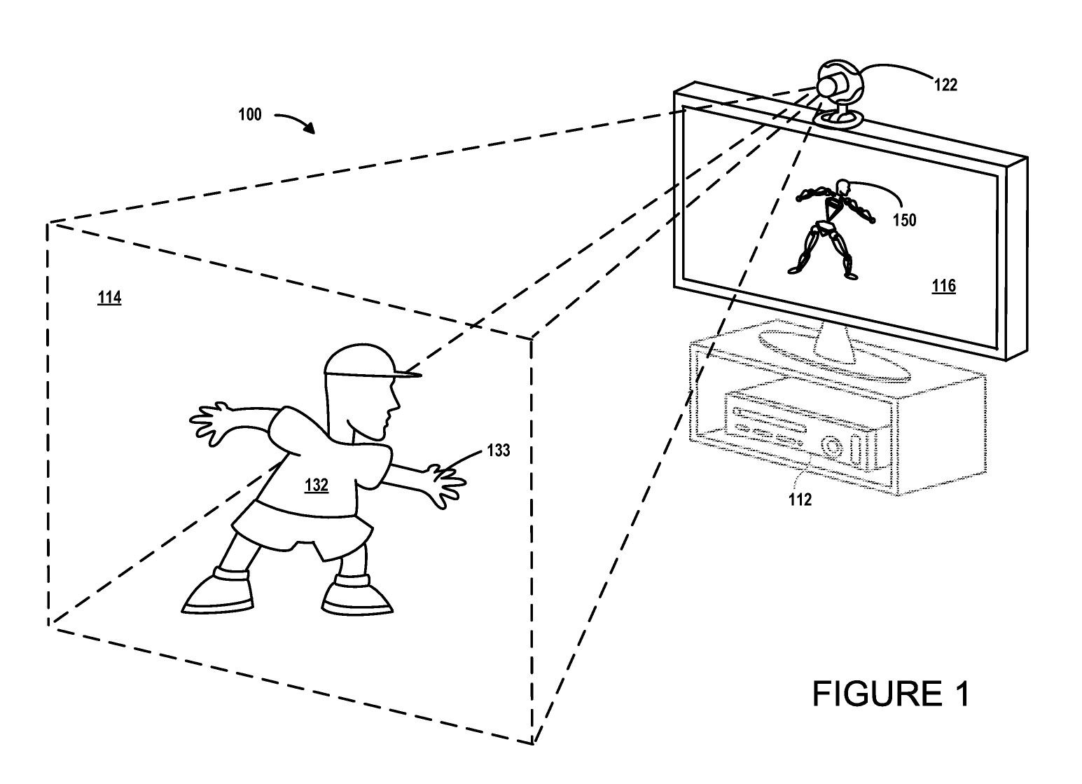

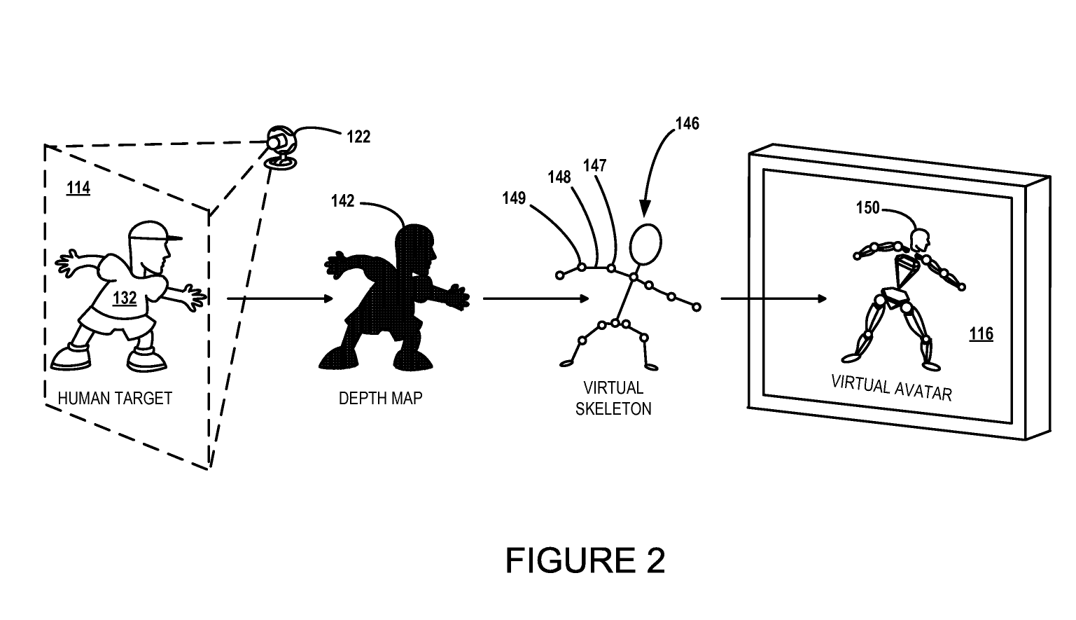

Turning now to FIGS. 1 and 2, details will be provided regarding an illustrative operating environment and several software components provided by the embodiments presented herein. An image analysis system 100 may include a gaming system 112 and a connected camera 122 capable of observing one or more players. For illustrative purposes, a player may also be referred to herein as a “human target 132.” As the camera 122 captures images of a human target 132 within an observed scene 114, those images may be interpreted by the gaming system 112 and modeled as one or more virtual skeletons 146. The relative position of a hand joint or other point of interest of the virtual skeleton 146 may be translated as a gestured control.

As described in more detail below, with the use of dynamically filtered data, the camera 122 and the gaming system 112 can observe and model the human target 132 performing gestures to control an avatar 150 with a high level of accuracy. Filtering techniques described herein may assist with the interpretation of specific states of many types of input, such as the position of finger joints forming a first or an open-hand gesture. As also described below, the human target 132 may accurately control other aspects of the avatar 150 or other user interface elements to improve the overall user experience.

FIG. 1 shows a non-limiting example of the image analysis system 100. In particular, FIG. 1 shows a gaming system 112 that may be used to play a variety of different games, play one or more different media types, and/or control or manipulate non-game applications and/or operating systems. FIG. 1 also shows a display device 116 such as a television or a computer monitor, which may be used to present game visuals to game players. As one example, display device 116 may be used to visually present an avatar 150, which the human target 132 may control with his or her movements. The image analysis system 100 may include a capture device connected to the gaming system 112, such as a camera 122, that visually monitors or tracks the human target 132 within an observed scene 114.

The human target 132 is shown here as a game player within an observed scene 114. The human target 132 may be tracked by the camera 122 so that the movements of human target 132 may be interpreted by gaming system 112 as controls that may be used to affect the game being executed by gaming system 112. In other words, human target 132 may use his or her movements to control a game or other type of application. The movements of human target 132 may be interpreted as virtually any type of game control. Some movements of human target 132 may be interpreted as controls that serve purposes other than controlling avatar 150. As non-limiting examples, movements of human target 132 may be interpreted as controls that steer a virtual racing car, throw a virtual bowling ball, pull a lever or push a button of a virtual control panel, or manipulate various aspects of a simulated world. Movements may also be interpreted as auxiliary game management controls. For example, human target 132 may use movements to end, pause, save, select a level, view high scores, communicate with other players, etc.

As will be described below, gestures of the human target 132 may include the interpretation of input data that describes a state of an object, such as a hand 133 of the human target 132. As the hand 133 of the human target 132 opens and closes, different gestures may be interpreted to direct the gaming system 112 or any other computing device receiving the input data. Although the examples described herein involve input data that describes the state of a hand, it can be appreciated that other objects of the human target 132 fall within the scope of the present disclosure.

The camera 122 may also be used to interpret target movements for operating system and/or application controls that are outside the realm of gaming. Virtually any controllable aspect of an operating system and/or application may be controlled by movements of a human target 132. The illustrated scenario in FIG. 1 is provided as an example, but is not meant to be limiting in any way. To the contrary, the illustrated scenario is intended to demonstrate a general concept, which may be applied to a variety of different applications without departing from the scope of this disclosure.

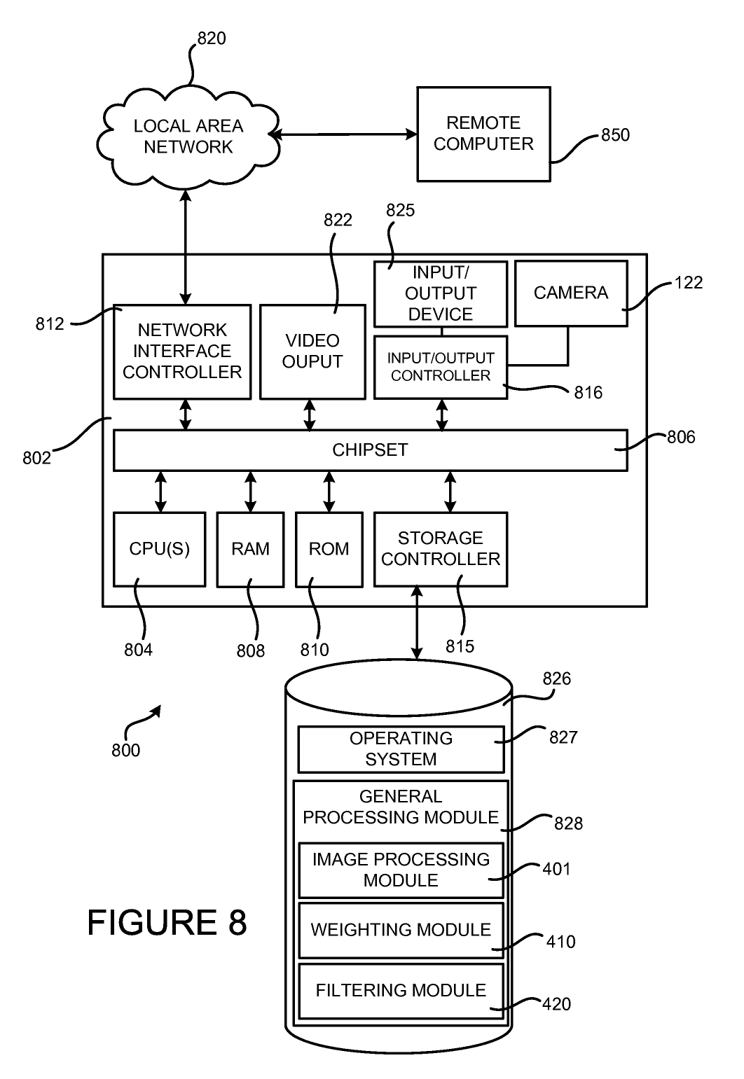

The methods and processes described herein may be used on a variety of different types of computing systems. FIG. 1 shows a non-limiting example that includes the gaming system 112, display device 116, and camera 122. As can be appreciated, although the example of FIG. 1 includes the gaming system 112, the image analysis system 100 may also include a general computing device, such as computing device 800 shown in FIG. 8.

FIG. 2 shows a simplified processing pipeline in which human target 132 in an observed scene 114 is modeled as a virtual skeleton 146 that can be used to draw an avatar 150 on display device 116 and/or serve as a control input for controlling other aspects of a game, application, and/or operating system. It will be appreciated that a processing pipeline may include additional steps and/or alternative steps than those depicted in FIG. 2 without departing from the scope of this disclosure.

As shown in FIG. 2, the human target 132 and the remainder of the observed scene 114 might be imaged by a capture device, such as the camera 122. The camera 122 may determine, for each pixel, the depth of a surface in the observed scene relative to the camera. Virtually any depth finding technology may be used without departing from the scope of this disclosure. For example, infrared, radio or light signals may be used to measure the distance between the camera 122 and an object.

A depth map 142 may be used to store a depth value for each pixel of a captured image. Such a depth map may take the form of virtually any suitable data structure, including but not limited to a matrix that includes a depth value for each pixel of the observed scene. As can be appreciated, a depth value may indicate a distance between the camera 122 and an object represented by any given pixel. In FIG. 2, depth map 142 is schematically illustrated as a pixelated grid of the silhouette of human target 132. This illustration is for simplicity of understanding, not technical accuracy. It is to be understood that a depth map generally includes a depth value for all pixels, not just pixels that image human target 132, and that the perspective of camera 122 would not result in the silhouette depicted in FIG. 2.

Virtual skeleton 146 may be derived from depth map 142 to provide a machine-readable representation of human target 132. In other words, virtual skeleton 146 is derived from depth map 142 to model human target 132. The virtual skeleton 146 may be derived from the depth map in any suitable manner. In some embodiments, one or more skeletal fitting algorithms may be applied to the depth map. The present disclosure is compatible with virtually any skeletal modeling technique.

The virtual skeleton 146 may include a plurality of joints, each joint corresponding to a portion of the human target. In FIG. 2, virtual skeleton 146 is illustrated as a fifteen joint stick figure. This illustration is for simplicity of understanding, not technical accuracy. Virtual skeletons in accordance with the present disclosure may include virtually any number of joints, each of which can be associated with virtually any number of parameters (e.g., three dimensional joint position, joint rotation, body posture of corresponding body part (e.g., hand open, hand closed, etc.) etc.). It is to be understood that a virtual skeleton may take the form of a data structure including one or more parameters for each of a plurality of skeletal joints and the connections between each joint. For example, the virtual skeleton 146 may include a shoulder joint 147, an arm 148 and an elbow joint 149. In an example data structure, the virtual skeleton 146 may be a joint matrix including an x position, a y position, a z position, and a rotation for each joint. In some embodiments, other types of virtual skeletons may be used (e.g., a wireframe, a set of shape primitives, etc.).

As shown in FIG. 2, an avatar 150 may be rendered on display device 116 as a visual representation of virtual skeleton 146. Because virtual skeleton 146 models human target 132, and the rendering of the avatar 150 is based on the virtual skeleton 146, the avatar 150 serves as a viewable digital representation of the human target 132. As such, movement of avatar 150 on display device 116 reflects the actual movements of the human target 132.

In some embodiments, only portions of an avatar 150 will be presented on display device 116. As one non-limiting example, display device 116 may present a first person perspective to human target 132 and may, therefore, present the portions of the avatar 150 that could be viewed through the virtual eyes of the avatar (e.g., outstretched hands holding a steering wheel, outstretched hands holding a bowling ball, outstretched hands grabbing a virtual object in a three-dimensional virtual world, etc.).

While avatar 150 is used as an example aspect of a game that may be controlled by the movements of the human target 132 via the skeletal modeling of the depth map 142, this example is not intended to be limiting. A human target 132 may be modeled with a virtual skeleton 146, and the virtual skeleton 146 may be used to control aspects of a game or other application other than an avatar 150. For example, the movement of the human target 132 may control a game or other application, such as a spreadsheet or presentation application, even if an avatar is not rendered to the display device.

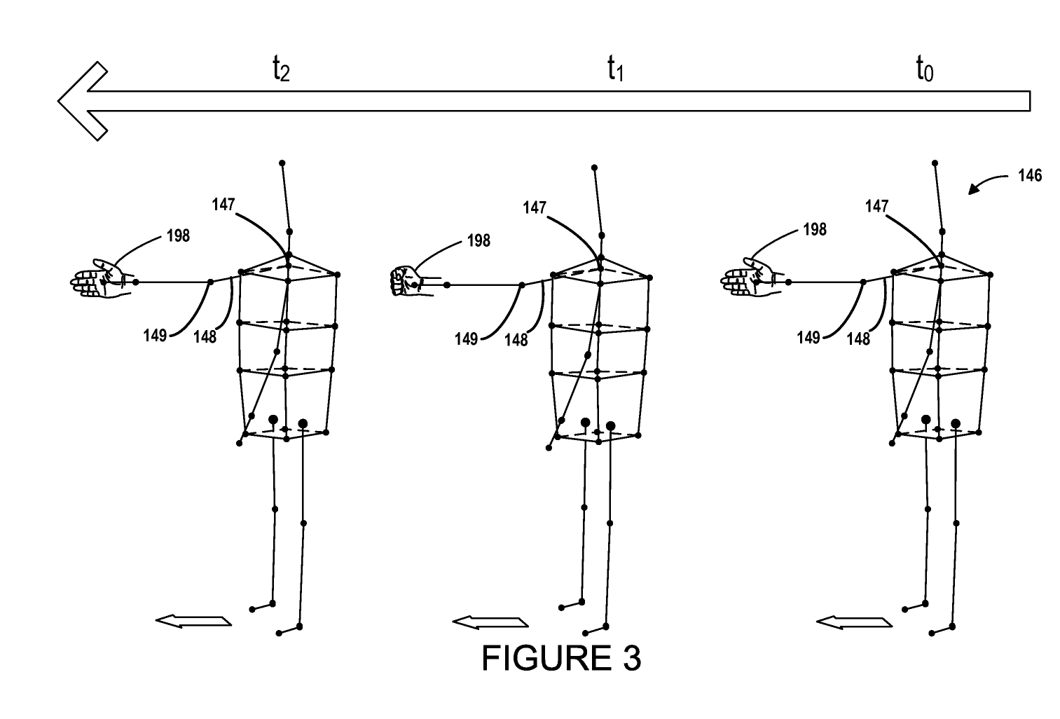

As introduced above, a simulation game may be controlled by the movements of the human target 132 via the skeletal modeling of a depth map 142. For example, FIG. 3 shows a virtual skeleton 146 modeling different gestures of a human target 132 at different moments in time (e.g., time t₀, time t₁, and time t₂). As discussed above, virtual skeleton 146 may be derived from depth information acquired from a camera observing the human target. While virtual skeleton 146 is illustrated as a jointed stick figure, it is to be understood that the virtual skeleton may be represented by any suitable machine-readable data structure. For example, the joints, e.g., the shoulder joint 147 and the elbow joint 149 connecting the arm 148, illustrated as dots in FIG. 3 may be represented by positional coordinates and/or other machine-readable information. As such, a logic subsystem of a computing system may receive the virtual skeleton (i.e., data structure(s) representing the virtual skeleton in machine readable form) and process the position and/or other attributes of one or more joints. In this way, the skeletal position/movement, and therefore the gestures of the modeled human target may be interpreted as different gestured controls for controlling the computing system.

For illustrative purposes, FIG. 3 shows a hand 198 of the virtual skeleton 146 at two different states: an open state or a closed state. For illustrative purposes, the state of the hand is depicted with a graphic of an open and closed hand. Although a graphic is used to illustrate the state of one hand, it can be appreciated that data representing the skeletal data may store and represent the state of the hand using a number of computerized techniques. As indicated at time t₀, the hand 198 of the virtual skeleton is in an open position. At time t₁, the hand 198 is in a closed position, and at time t₂, the hand 198 is in an open position again. As can be appreciated, the state of the hand 198, e.g., it being closed or open, can be determined by the use of a number of imaging techniques, such as those described above involving a depth map 142, skeletal fitting algorithms and/or a number of other imaging algorithms.

In embodiments described herein, the image analysis system 100 may be configured to interpret the state of a portion of the human target 132, such as the hand, by the position of the fingers and the overall shape. In such cases, the portion of the depth map and/or color image including the hand may be evaluated to determine if the hand is in an open or closed posture. For example, the portion of the depth map and/or color image including the hand may be analyzed with reference to a prior trained collection of known hand postures to find a best match hand posture. As described below, raw data samples may be generated by the image analysis system 100, and each raw data sample may include state data, which indicates if an object is open, closed or otherwise. By techniques described herein a weighting and filtering process may be utilized to improve the interpretation of the raw data samples.

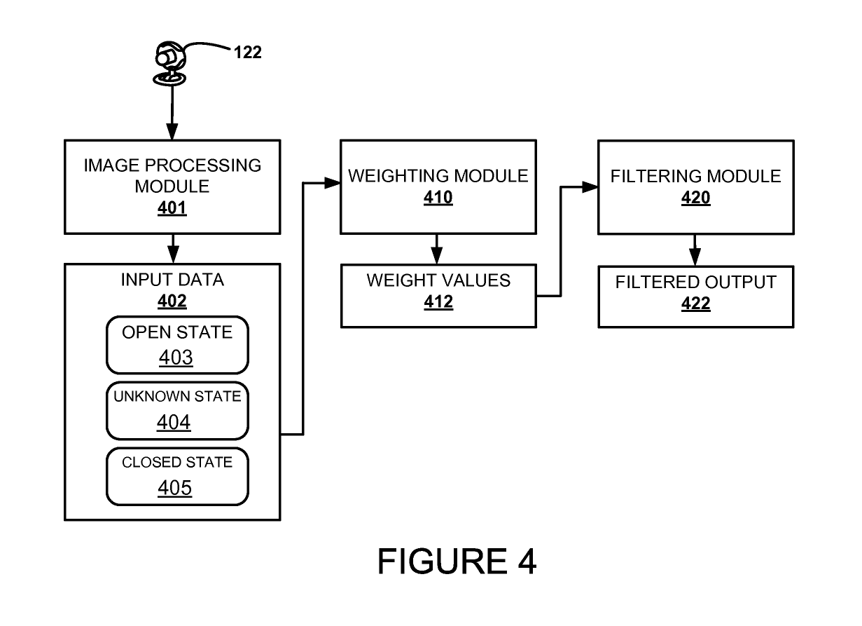

FIG. 4 illustrates example components for processing image data produced by a camera 122 into a filtered output 422 characterizing an interpreted state of one or more objects, e.g., a hand, of the human target 132. Generally described, the camera 122 produces image data, which may include a color image, a monochrome image, depth information and/or other like information. The image data may be processed by an image processing module 401 to generate input data 402 that indicates at least one state of an object. The image processing module 401 may be, for example, any software or hardware module configured to generate data that indicates a state, e.g., an open state or closed state, of an object. As can be appreciated, a state of the one or more objects of the human target 132 may represent an open state or a closed state.

In one illustrative example, the input data 402 may include several categories of states, also referred to herein as “state categories.” For example, in the illustration of FIG. 4, the example state categories for a human hand include: an open state 403 indicating that a hand is open, an unknown state 404 indicating that the state of the hand is unknown, and a closed state 405 indicating that the hand is closed. Although this illustrative example includes only three state categories for a human hand, it can be appreciated that fewer or more states may be used to implement the techniques described herein with regard to the human hand or other body parts.

Also shown in FIG. 4, the input data 402 may be utilized by a weighting module 410 that associates a weight value to individual state categories. As will be described in more detail below, a weight value, or other quantifiable value, is associated with individual state categories based on a scenario of a virtual world environment. As described in more detail below, the weight value associated with an individual state category may be based on a number of factors, events and/or conditions established in any application utilizing the techniques described herein. The weight values 412 may then be utilized by a filtering module 420 to generate a filtered output 422, which may be used to control a virtual skeleton 146, an avatar 150, or another aspect of the operation of a computing device.

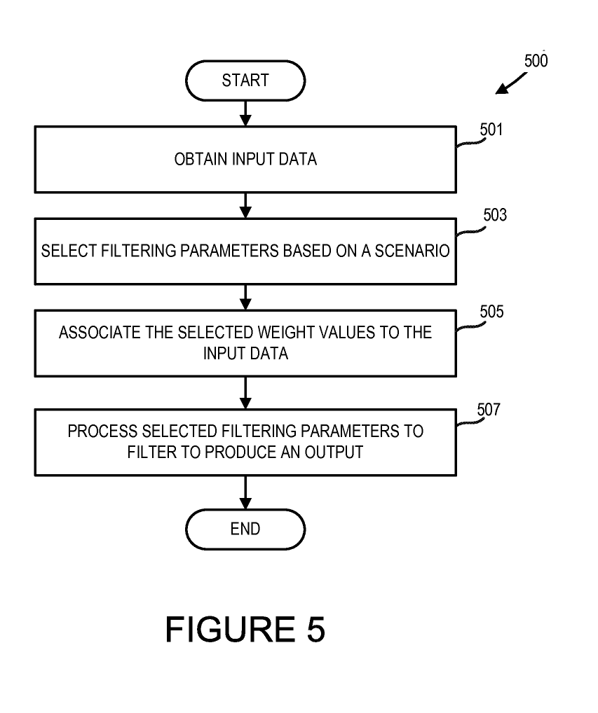

Referring now to FIG. 5, a flow diagram showing aspects of one illustrative routine 500 for dynamically directing an interpretation of input data based on contextual information will be described. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. Thus, it also should be understood that the illustrated methods may be ended at any time and need not be performed in its entirety. These operations may also be performed in a different order than those described herein.

Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

As will be described in more detail below in the description of FIG. 8, the operations of the routine 500 are described herein as being implemented on a computing device, such as the gaming system 112, which may execute several components for supporting the functions and operations described herein. For example, the image processing module 401, the weighting module 410 and the filtering module 420 may be part of a general processing module 828 that executes on a processor-based system, such as the computing device 800 shown in FIG. 8, which could be used to implement the gaming console 112.

Although the following illustration refers to a general processing module executing on computing device, it can be appreciated that the operations of the routine 500 may be also implemented in many other ways. For example, the routine 500 may be implemented in a computer operating system, a productivity application, or any other application that processes input data. In addition, one or more of the operations of the routine 500 may alternatively or additionally be implemented, at least in part, by a software component working in conjunction with an application operating on a remote computer, such as the remote computer 850 of FIG. 8. These operations might also be implemented in hardware and/or a combination of software and hardware.

The routine 500 begins at operation 501 where the general processing module obtains input data 402 describing the physical state of a human target 132. As discussed above, the input data 402 may be in any format and may contain any type of information that describes one or more states of the human target 132. Although FIG. 4 shows one illustrative embodiment, it can be appreciated that the examples detailed herein are for illustrative purposes only and are not to be construed as limiting. Embodiments of the routine 500 and other techniques described herein may use any type of data format that describes one or more physical states of a human target 132. As also can be appreciated, in one embodiment, a general processing module may generate the input data 402 by use of various modules, such as the image processing module 401. In addition, it can be appreciated that the input data 402 may be generated by an external computing device and the input data 402 may be received by the image analysis system 100.

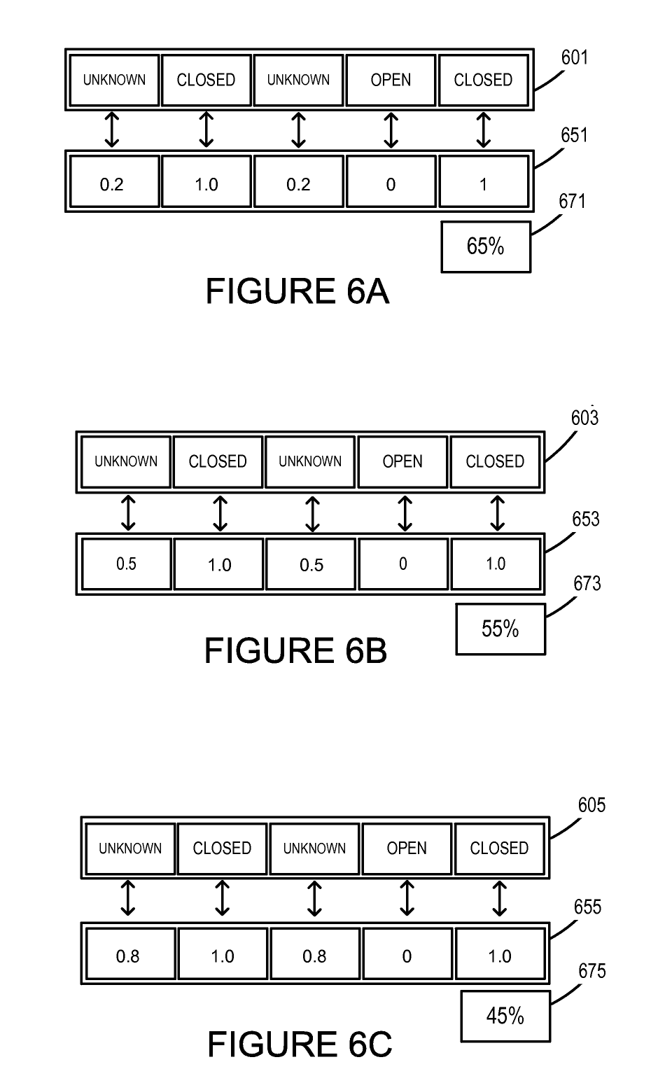

FIGS. 6A-6C, illustrate one example of input data 402 that may be obtained in operation 501. The input data 402 may be in the form of an input sample set, such as input sample sets 601-605, and each input sample set includes individual input data samples. As will be described in more detail below, individual input data samples are interpreted using a filtering process to provide more stable results as the input data 402 is processed into the filtered output 422. As can be appreciated, although the illustrative embodiments show input sample sets, such as sample set 601, sample set 603 and sample set 605, with only five individual input data samples, it can be appreciated that implementations of routine 500 may include more or fewer individual input data samples.

Returning to FIG. 5, next, at operation 503, the general processing module selects filtering parameters based on a scenario. As summarized above, the image analysis system 100 is configured to control a scenario within a virtual environment. A scenario may include any action, setting, surrounding, and/or any circumstance associated with the avatar. As scenarios are introduced during runtime, the filtering parameters are dynamically selected to alter the interpretation of the input data as different scenarios are introduced. As described below, the filtering parameters selected in operation 503 may include a range of weight values and one or more thresholds.

According to various embodiments, contextual information describing objects and actions of the virtual environment may be utilized at operation 503 to select the filtering parameters. For example, the speed, direction and/or position of one or more objects in the virtual environment may be considered. Other contextual information regarding a scenario, such as the nature of an object or the nature of an action performed by or on one or more objects might also be taken into account. For instance, and as will be described in more detail below, different sets of filtering parameters may be selected for different scenarios involving various objects and actions. For example, as described in more detail below, a first set of filtering parameters may be selected for a scenario where an avatar is holding a bowling ball, and a second set of filtering parameters may be selected for a scenario where an avatar is throwing a bowling ball.

In one embodiment, a device or software component may be configured with predetermined sets of filtering parameters. In such an embodiment, each set of filtering parameters defines individual filtering levels that influence the interpretation of the input data 402. For illustrative purposes, a specific example includes three filtering levels: a LOOSE filtering level, a NORMAL filtering level and a STRICT filtering level. For example, the LOOSE filtering level may include a range of weight values: 0, 0.2 and 1.0. In addition, the LOOSE filtering level may include a threshold of 65%. The NORMAL filtering level may include a range of weight values: 0, 0.5 and 1.0. The NORMAL filtering level may include a threshold of 60%. The STRICT filtering level may include a range of weight values: 0, 0.8 and 1.0. The STRICT filtering level may include a threshold of 45%. In this example, as will be described in more detail below, sets of filtering parameters and the corresponding filtering levels are associated with one or more scenarios. Thus, when a particular scenario is encountered during runtime, a specific set of filtering parameters would be selected while the scenario is in effect.

Although embodiments disclosed herein may involve a range of weight values and a range of thresholds that vary based upon a scenario, it can be appreciated that embodiments of routine 500 may independently vary the weight values and the threshold. It may also be appreciated that the weight values may be selected based on contextual information and other factors, while the threshold remains at a fixed value. In addition, it may also be appreciated that the threshold may be selected based on contextual information and other factors, while the weight values remain at a fixed level.

As can be appreciated, the predetermined sets of filtering parameters may have many filtering levels to accommodate different settings. For instance, the range of weight values may include a variety of values, such as 0, 0.1, and 1.0. In another example, the range may include values such as: 0, 0.9 and 1.0. At the same time, the threshold associated with such range values may have a broader range as well. Depending on the desired outcome, a threshold may include any number, such as 5% and 90%. As can be appreciated, the predetermined sets of filtering parameters are provided for illustrative purposes and are not to be construed as limiting.

Returning to FIG. 5, next, at operation 505, the selected filtering parameters are associated with the input data 402. Generally described, operation 505 involves a process where the selected weighting values are used to bias the input data 402. In one embodiment, the selected weighting values are associated with individual input data samples.

Specific to one implementation, the lowest weight value, such as a value of 0, may be associated with individual input data samples that indicate an OPEN state. The highest weight value, such as a value of 1, may be associated with individual input data samples that indicate a CLOSED state. The middle weight values, such as the middle values summarized above ranging from 0.2 to 0.8, may be associated with individual input data samples that indicate an UNKNOWN state. As explained below, the middle weight values may vary depending on one or more associated scenarios.

Referring again to FIGS. 6A-6C, one technique for associating the weighing values and individual input data samples is shown. Specifically, FIG. 6A depicts an input sample set 601 having five individual input data samples. As also shown, each individual input data sample describes a state of an input object of the human target 132. In particular, this example input sample set 601 includes five individual input data samples comprising the states: UNKNOWN, CLOSED, UNKNOWN, OPEN and CLOSED. In this example, the LOOSE filtering level and its associated filtering parameters, specifically the loose weighting values 651, are used. As shown, the middle range weight value, 0.2, is associated with the individual input data samples that indicate an UNKNOWN state. The high weight value, 1.0, is associated with the individual input data samples that indicate a CLOSED state. The low weight value, 0, is associated with the individual input data samples that indicate an OPEN state.

FIGS. 6B-6C also illustrate similar associations between individual input data samples of other input sample sets and weight values from different filtering levels. Details and related examples of FIGS. 6B-6C are provided below. As can be appreciated, these examples are provided for illustrative purposes only and are not to be construed as limiting. It can be appreciated that the filtering parameters may include more or fewer weighting values and they may be associated with more or fewer states, and associations between values and states can be done in different ways.

Returning to FIG. 5, next, at operation 507, the selected filtering parameters are used to generate an output, such as the filtered output 422, characterizing an interpreted state of one or more objects of the human target 132. As can be appreciated, the selected weight values may be processed in a number of ways to compare a product of the selected values to the selected threshold. For example, an average, mean or any other calculation involving the selected weight values may be used to generate a productized value that may be compared to the selected threshold. Various ways of implementing operation 507 may also associate the states of the individual input data samples with the selected weight values, such as the associations shown in FIGS. 6A-6C.

In one specific example, the selected weight values may be associated with individual input data samples, as described above, and those associated values may be averaged and compared to the selected threshold. With reference to the first example input sample set 601 and the associated filtering parameters, i.e., the loose weight values 651 and loose threshold 671 of FIG. 6A, one example calculation may include the equation: (0.2+1.0+0.2+0+1.0)/5=0.48=48%. Once this resulting product of the weight values is calculated, the general processing module then compares the resulting product to the selected threshold, i.e., the loose threshold 671 having a value of 65%. In such a result, where the resulting product of the weight values is less than the selected threshold, and given that this example data associates a value of zero (0) with the OPEN state and associates a value of one (1) with the CLOSED state, the filtered output 422 would indicate an OPEN state.

In the current example, utilizing the loose weight values 651 and loose threshold 671, if the object was in a CLOSED state prior to receiving the input sample set 601, the general processing module would change the state of the object to an OPEN state upon the processing of the input sample set 601. However, if the object was in an OPEN state prior to receiving the input sample set 601, the general processing module would keep the object in the OPEN state upon the processing of the input sample set 601.

As can be appreciated, the weight values and the threshold of the LOOSE filtering level may bias the interpretation of the input data 402 to accommodate a number of virtual environment scenarios. Given that the middle weight value, e.g., 0.2, is associated with the input data samples indicating an UNKNOWN state, the techniques described herein allow for unreliable input data samples to be slightly biased toward an OPEN state. This interpretation is helpful in scenarios where it is not desirable to have a number of false positive results that lead to a CLOSED state.

For example, consider a scenario where an avatar may grab a virtual control lever by placing the avatar's hand near the lever and performing a gesture where the human target 132 changes the state of their hand from an open state to a closed state. In such a scenario, when the avatar's hand is moving at a high velocity over the lever, it is fairly unlikely that there is a desire to grab the virtual control lever. Thus, in such a scenario when the avatar's hand is moving at a high velocity, techniques disclosed herein reduce the number of false positive interpretations of input data that concludes that the avatar has closed their hand over the virtual control lever. In such a scenario, in operation 503 of routine 500, the general processing module would select filtering parameters from the LOOSE filtering level to interpret input data. As a result, while the scenario is in effect, the filtered output 422 would be biased toward an OPEN state. Biasing the interpretation of the input data in this way may be utilized to mitigate experiences where the avatar gets their hand stuck on levers they do not intend to grab.

In the above-described example involving the avatar and the virtual control lever, if the scenario changes slightly, it may desirable to change the interpretation of the input data 402. For example, when the hand of the avatar is held in a position near the virtual control lever, as opposed to moving at a high velocity, it may be desirable to use a different set of filtering parameters, such as the NORMAL filtering level described above.

FIG. 6B illustrates one example of how the NORMAL filtering parameters may be applied to a second example input set 603. In this example, the middle weight value, e.g., 0.5, is associated with the individual input data samples that indicate an UNKNOWN state. In addition, the lowest weight value, e.g., the value of zero (0), is associated with the individual input data samples that indicate an OPEN state. The highest weight value, e.g., the value of one (1), is associated with individual input data samples that indicate a CLOSED state.

When the second example input set 603 is associated with the NORMAL weight values 653, the product of the average is (0.5+1.0+0.5+0+1.0)/5=0.6=60%. This product, when compared to the NORMAL threshold 673, which has a value of 55%, results in a filtered output 422 that indicates a CLOSED state. As can be appreciated, when the results produced by the LOOSE filtering level are compared to the results produced by the NORMAL filtering level, the output produced by the NORMAL filtering parameters is less biased toward the OPEN state.

In the current example, utilizing the NORMAL weight values 653 and NORMAL threshold 673, if the object was in an OPEN state prior to receiving the input sample set 603, the general processing module would change the state of the object to a CLOSED state upon the processing of the input sample set 603. However, if the object was in a CLOSED state prior to receiving the input sample set 603, the general processing module object would be kept in the CLOSED state upon the processing of the input sample set 603.

In other scenarios, it may be desirable to bias the filtered output 422 toward a CLOSED state. For instance, in a virtual environment where an avatar is throwing a bowling ball, it is fairly unlikely that the human target would release the bowling ball in the back swing. When such a scenario is presented during runtime, in operation 503 of routine 500, filtering parameters may be selected from the STRICT filtering level to interpret input data. As a result, while the scenario is in effect, the filtered output 422 would be biased toward a CLOSED state. Biasing the interpretation of the input data in this way may mitigate experiences where the avatar releases the bowling ball at undesirable times.

FIG. 6C illustrates one example of how the STRICT filtering parameters may be applied to a third example input set 605. In this example, the middle weight value, e.g., 0.8, is associated with the individual input data samples that indicate an UNKNOWN state. In addition, the lowest weight value, e.g., the value of zero (0), is associated with the individual input data samples that indicate an OPEN state. The highest weight value, e.g., the value of one (1), is associated with individual input data samples that indicate a CLOSED state.

When the third example input set 605 is associated with the STRICT weighting values 655, the product of the average is (0.8+1.0+0.8+0+1.0)/5=0.72=72%. This product, when compared to the STRICT threshold 675, which has a value of 45%, results in a filtered output 422 that indicates a CLOSED state. As can be appreciated, when the results of the STRICT filtering level are compared to the results of the LOOSE filtering level or NORMAL filtering level, the output produced by the STRICT filtering level is more biased towards the CLOSED state.

In the current example utilizing the STRICT filtering parameters 655 and STRICT threshold 675, if the object was in an OPEN state prior to receiving the input sample set 605, the general processing module would change the state of the object to a CLOSED state upon the processing of the input sample set 605. However, if the object was in a CLOSED state prior to receiving the input sample set 605, the general processing module would keep the object in the CLOSED state upon the processing of the input sample set 605.

As a result of utilizing the above-described three sample filtering levels, various filtering parameters may be dynamically applied to various scenarios to produce more desirable interpretations of the input data. With reference to the bowling example, in scenarios where the avatar is simply holding a bowling ball, the filtering parameters of the NORMAL filtering level may be selected. As described above, filtering parameters of the STRICT filtering level may be dynamically selected during the first half of the swing gesture, e.g., the back swing, which makes it more difficult to actually release the ball. This is a desirable interpretation as it is fairly unlikely that the player would want to release the ball during the back swing. However, once the player's hand is moving forward, the filtering parameters of the LOOSE filtering level or the NORMAL filtering level may be selected to better align the interpretation of the input data with the scenario.

With reference to the example where a human target is controlling an avatar grabbing a virtual lever, once the lever is grabbed by the avatar, the filtering parameters of the STRICT filtering level may be selected. The use of such parameters in this scenario has a number of benefits. For instance, when using the parameters of the STRICT filtering level, the filtered result may be more likely to stay in a CLOSED state even when the input data becomes more unreliable. As can be appreciated, input data may become more unreliable when the human target 132 is moving an object, such as a hand, at a high velocity. Without the use of the filtering parameters of the STRICT filtering level, input data that is categorized as UNKNOWN may cause undesirable results even when a closed hand of the human target 132 is moved at a high velocity. As can be appreciated, the use of the STRICT filtering level may require a more confident input indicating an OPEN state to change the state of the object.

Although illustrative examples herein include scenarios involving a bowling ball, lever and other objects and activities, it can be appreciated that techniques herein may apply to a wide range of scenarios. In addition, it can be appreciated that more or fewer filtering levels may be defined by any number of weight values and/or thresholds. For example, there may be embodiments where the weight values are fixed, and the filtering threshold varies depending on the scenario. It can be appreciated that the filtering parameters may be generated during runtime to dynamically create different characteristics of the input data. For example, the weight values and/or the threshold may dynamically change based on a number of factors, such as the position, velocity and/or the direction of motion of one or more objects, such as the virtual object or an object of the human target.

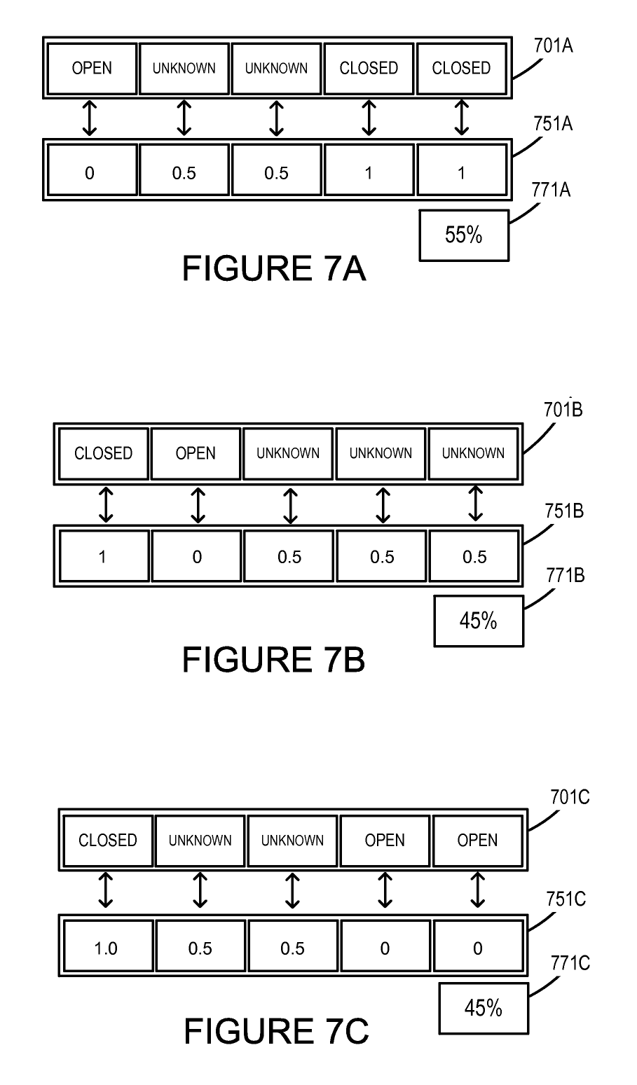

FIGS. 7A-7B illustrate examples of other example filtering parameters, which include example weight values 751A-751C and example filtering thresholds 771A-771C, that are applied to input data samples 701A-701C. As shown, these example filtering parameters show an embodiment where the individual weight values are fixed. For illustrative purposes, the example weight value is 0.5. As can be appreciated, this example value is provided for illustrative purposes and it is not to be construed as limiting. As can be appreciated the weight value may be applied to the input data samples 751A-751C using techniques described above. As can also be appreciated, the example filtering thresholds 771A-771C may vary depending on a desired interpretation of the input data samples 701A-701C.

Referring to FIG. 7A, the example data includes an input sample set 701A having five individual input data samples. Using the techniques described above, the individual input data samples are associated with the weight values 751A. In applying this example data to a scenario where an object of an avatar starts in an OPEN state, e.g., an open hand, the above-described routine 500 would process the input sample set 701A and generate an output indicating the object is to transition to a CLOSED state. For example, in using the averaging embodiment described above, the input data sample 701A would produce a product of 60% which is over the threshold 771A of 55%, thus producing an output describing a CLOSED state.

Referring to FIG. 7B, another set of example data includes an input sample set 701B having five individual input data samples. Using the techniques described above, the individual input data samples are associated with the weight values 751B. In applying this example data to a scenario where an object of an avatar starts in a CLOSED state, e.g., a fist, the above-described routine 500 would process the input sample set 701B and generate an output indicating the object should remain in a CLOSED state. For example, in using the averaging embodiment described above, the input data sample 701B would produce a product of 50%, which is over the threshold 771B of 45%, thus producing an output describing a CLOSED state.

Referring to FIG. 7C, yet another set of example data includes an input sample set 701C having five individual input data samples. Using the techniques described above, the individual input data samples are associated with the weight values 751C. In applying this example data to a scenario where an object of an avatar starts in an CLOSED state, e.g., a fist, the above-described routine 500 may process the input sample set 701C and generate an output indicating the object is to transition to an OPEN state. For example, in using the averaging embodiment described above, the input data sample 701C would produce a product of 40%, which is under the threshold 771C of 45%, thus producing an output describing an OPEN state. As can be appreciated, the use of the various filtering thresholds, even with a fixed weight value, improves the stability of the filtered output.

FIG. 8 shows additional details of an example computer architecture for the components shown in FIGS. 1 and 4 capable of executing the program components described above for dynamically directing an interpretation of input data based on contextual information. The computer architecture shown in FIG. 8 illustrates the components of a computing device 800, which may be embodied in a game console, such as the gaming system 112 shown in FIG. 1, conventional server computer, workstation, desktop computer, laptop, tablet, phablet, network appliance, personal digital assistant (“PDA”), e-reader, digital cellular phone, or other computing device, and may be utilized to execute any of the software components presented herein. For example, the computer architecture shown in FIG. 8 may be utilized implement a computer configured to execute any of the software components described above.

The computing device 800 includes a baseboard 802, or another medium, such as a “motherboard,” which is a printed circuit board to which a multitude of components or devices may be connected by way of a system bus or other electrical communication paths. In one illustrative embodiment, one or more central processing units (“CPUs”) 804 operate in conjunction with a chipset 806. The CPUs 804 may be standard programmable processors that perform arithmetic and logical operations necessary for the operation of the computing device 800.

The CPUs 804 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 may provide an interface to a RAM 808, used as the main memory in the computing device 800. The chipset 806 may further provide an interface to a computer-readable storage medium such as a read-only memory (“ROM”) 810 or non-volatile RAM (“NVRAM”) for storing basic routines that help to startup the computing device 800 and to transfer information between the various components and devices. The ROM 810 or NVRAM may also store other software components necessary for the operation of the computing device 800 in accordance with the embodiments described herein.

The computing device 800 may operate in a networked environment using logical connections to remote computing devices and computer systems through a network, such as the local area network 820. The chipset 806 may include functionality for providing network connectivity through a network interface controller (NIC) 812, such as a gigabit Ethernet adapter. The NIC 812 is capable of connecting the computing device 800 to other computing devices over the network 820. It should be appreciated that multiple NICs 812 may be present in the computing device 800, connecting the computer to other types of networks and remote computer systems. The local area network 820 allows the computing device 800 to communicate with remote services and servers, such as the remote computer 850. As can be appreciated, the remote computer 850 may host a number of services such as the XBOX LIVE gaming service provided by MICROSOFT CORPORATION of Redmond, Wash.

The computing device 800 may be connected to a mass storage device 826 that provides non-volatile storage for the computing device. The mass storage device 826 may store system programs, application programs, other program modules, and data, which have been described in greater detail herein. The mass storage device 826 may be connected to the computing device 800 through a storage controller 815 connected to the chipset 806. The mass storage device 826 may consist of one or more physical storage units. The storage controller 815 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. It should also be appreciated that the mass storage device 826, other storage media and the storage controller 815 may include MultiMediaCard (MMC) components, eMMC components, Secure Digital (SD) components, PCI Express components, or the like.

The computing device 800 may store data on the mass storage device 826 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 826 is characterized as primary or secondary storage, and the like.

For example, the computing device 800 may store information to the mass storage device 826 by issuing instructions through the storage controller 815 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may further read information from the mass storage device 826 by detecting the physical states or characteristics of one or more particular locations within the physical storage units.

In addition to the mass storage device 826 described above, the computing device 800 may have access to other computer-readable media to store and retrieve information, such as program modules, data structures, or other data. Thus, although the image processing module 401, weighting module 410, filtering module 420 and other modules are depicted as data and software stored in the mass storage device 826, it should be appreciated that these components and/or other modules may be stored, at least in part, in other computer-readable storage media of the computing device 800. It can be appreciated that the image processing module 401, the weighting module 410 and the filtering module 420 may be part of the general processing module 828, which may also manage other functions described herein. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computing device 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computing device 800. For purposes of the claims, the phrase “computer storage medium,” and variations thereof, does not include waves or signals per se and/or communication media.

The mass storage device 826 may store an operating system 827 utilized to control the operation of the computing device 800. According to one embodiment, the operating system comprises a gaming operating system. According to another embodiment, the operating system comprises the WINDOWS® operating system from MICROSOFT Corporation. According to further embodiments, the operating system may comprise the UNIX, ANDROID, WINDOWS PHONE or iOS operating systems. It should be appreciated that other operating systems may also be utilized. The mass storage device 826 may store other system or application programs and data utilized by the computing device 800, such as the input data 402, weight values 412, filtered output 422 and/or any of the other software components and data described above. The mass storage device 826 might also store other programs and data not specifically identified herein.

In one embodiment, the mass storage device 826 or other computer-readable storage media is encoded with computer-executable instructions which, when loaded into the computing device 800, transform the computer from a general-purpose computing system into a special-purpose computer capable of implementing the embodiments described herein. These computer-executable instructions transform the computing device 800 by specifying how the CPUs 804 transition between states, as described above. According to one embodiment, the computing device 800 has access to computer-readable storage media storing computer-executable instructions which, when executed by the computing device 800, perform the various routines described above with regard to FIG. 5. The computing device 800 might also include computer-readable storage media for performing any of the other computer-implemented operations described herein.

The computing device 800 may also include one or more input/output controllers 816 for receiving and processing input from a number of input devices, such as a keyboard, a mouse, a microphone, a headset, a touchpad, a touch screen, an electronic stylus, or any other type of input device. Also shown, the input/output controller 816 is in communication with an input/output device 825. The input/output controller 816 may provide output to a display, such as a computer monitor, a flat-panel display, a digital projector, a printer, a plotter, or other type of output device. The input/output controller 816 may provide input communication with other devices such as the camera 122, game controllers and/or audio devices. In addition, or alternatively, a video output 822 may be in communication with the chipset 806 and operate independent of the input/output controllers 816. It will be appreciated that the computing device 800 may not include all of the components shown in FIG. 8, may include other components that are not explicitly shown in FIG. 8, or may utilize an architecture completely different than that shown in FIG. 8.

Based on the foregoing, it should be appreciated that technologies for dynamically directing an interpretation of input data are provided herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for processing a plurality of input data samples, wherein individual data samples of the plurality of input data samples indicate a state of an input object, and wherein the input object is represented by a virtual object, the computer-implemented method comprising:
associating, at a computing device, one or more weight values with the plurality of input data samples;
selecting, at the computing device, a threshold based on a scenario associated with the virtual object;
determining, at the computing device, if a product of the one or more weight values associated with the plurality of input data samples meets the threshold; and
changing a state of the virtual object, at the computing device, if it is determined that the product of the one or more weight values associated with the plurality of input data samples meets the threshold.

2. The computer-implemented method of claim 1, further comprising, selecting the one or more weight values, and wherein the one or more weight values are biased based on the scenario.

3. The computer-implemented method of claim 1, wherein the individual data samples of the plurality of input data samples describe an open state, a closed state or an unknown state, and wherein associating the one or more weight values with the plurality of input data samples comprises:
associating a low weight value to individual data samples describing the open state;
associating a middle weight value to individual data samples describing the unknown state;
associating a high weight value to individual data samples describing the closed state; and
determining the product of the one or more weight values by averaging the one or more weight values associated with the plurality of input data samples.

4. The computer-implemented method of claim 1, wherein the selection of the threshold is based on the scenario, the scenario defining a movement of the virtual object in a predetermined direction.

5. The computer-implemented method of claim 1, wherein the selection of the threshold is based on the scenario, the scenario defining a movement of the virtual object within a predetermined velocity range.

6. The computer-implemented method of claim 1, wherein the selection of the threshold is based on the scenario, the scenario defining a predetermined location of the virtual object.

7. The computer-implemented method of claim 1, wherein the selection of the threshold is based on the scenario, the scenario defining a location of the virtual object relative to a location of another object.

8. A computer storage medium having computer-executable instructions stored thereupon which, when executed by a computing device, cause the computing device to:
select one or more weight values, wherein the one or more weight values are biased based on a scenario;
associate the one or more weight values with a plurality of input data samples, wherein individual data samples of the plurality of input data samples indicate a state of an input object, and wherein the input object is represented by a virtual object;
determine if a product of the one or more weight values associated with the plurality of input data samples meets a threshold; and
change a state of the virtual object if it is determined that the product meets the threshold.

9. The computer storage medium of claim 8, wherein the computer-executable instructions further cause the computing device to select the threshold based on a scenario associated with the virtual object.

10. The computer storage medium of claim 8, wherein the individual data samples of the plurality of input data samples describe an open state, a closed state or an unknown state, and wherein associate the one or more weighting values to the plurality of input data samples comprises:
associating a low weight value to individual data samples describing the open state;
associating a middle weight value to individual data samples describing the unknown state;
associating a high weight value to individual data samples describing the closed state; and
determining the product of the one or more weight values by averaging the one or more weight values associated with the plurality of input data samples.

11. The computer storage medium of claim 8, wherein the selection of the one or more weight values is based on the scenario, the scenario defining a movement of the virtual object in a predetermined direction.

12. The computer storage medium of claim 8, wherein the selection of the one or more weight values is based on the scenario, the scenario defining a movement of the virtual object within a predetermined velocity range.

13. The computer storage medium of claim 8, wherein the selection of the one or more weight values is based on the scenario, the scenario defining a predetermined location of the virtual object.

14. The computer storage medium of claim 8, wherein the selection of the one or more weight values is based on the scenario, the scenario defining a location the virtual object relative to a location of another object.

15. A computing device, comprising:
a processor; and
a memory having computer-executable instructions stored thereupon which, when executed by the processor, cause the computing device to
select one or more weight values, wherein a biasing of the one or more weight values is based on a scenario,
associate one or more weight values with a plurality of input data samples, wherein individual data samples of the plurality of input data samples indicate a state of an input object, and wherein the input object is represented by a virtual object,
select a threshold based on the scenario associated with the virtual object,
determine if a product of the one or more weight values associated with the plurality of input data samples meets the threshold, and
changing a state of the virtual object if it is determined that the product of the one or more weight values associated with the plurality of input data samples meets the threshold.

16. The computing device of claim 15, wherein the individual data samples of the plurality of input data samples describe an open state, a closed state or an unknown state, and wherein associating the one or more weighting values with the plurality of input data samples comprises:
associating a low weight value to individual data samples describing the open state;
associating a middle weight value to individual data samples describing the unknown state;
associating a high weight value to individual data samples describing the closed state; and
determining the product of the one or more weight values by averaging the one or more weight values associated with the plurality of input data samples.

17. The computing device of claim 15, wherein the selection of the weight values and the threshold are based on the scenario, the scenario defining a movement of the virtual object in a predetermined direction.

18. The computing device of claim 15, wherein the selection of the weight values and threshold are based on the scenario, the scenario defining a movement of the virtual object within a predetermined velocity range.

19. The computing device of claim 15, wherein the selection of the weight values and threshold are based on the scenario, the scenario defining a predetermined location of the virtual object.

20. The computing device of claim 15, wherein the selection of the weight values and threshold are based on the scenario, the scenario defining a location of the virtual object relative to a location of another object.
